(19) United States
(12) Patent Application Publication
(10) Pub. No.: US 2016/0217291 A1
(43) Pub. Date: Jul. 28, 2016

(54) TRANSACTION AUTOMATION FOR OPERATIONAL SYSTEMS

(71) Applicants: James R. Malnati, Stillwater, MN (US); John J. Troini, Gilroy, CA (US)

(72) Inventors: James R. Malnati, Stillwater, MN (US); John J. Troini, Gilroy, CA (US)

(73) Assignee: Unisys Corporation, Blue Bell, PA (US)

(21) Appl. No.: 14/602,621

(22) Filed: Jan. 22, 2015

(51) Int. Cl. G06F 21/60; G06F 21/62

(52) U.S. Cl. CPC G06F 21/604; G06F 21/6218

(57) ABSTRACT

Read-and-reply console messages may be received and a reply automatically generated. Further, a message system may test the availability of an automation sequence for a computing environment. Test commands may be transmitted to a system to test if automation is available. If automation is available, a message system may receive a read-and-reply console message and transmit the message to a host system where an automation sequence may be performed. After the automation sequence is verified, the read-and-reply console message may be answered.

### FIELD OF THE DISCLOSURE

The instant disclosure relates to system management. More specifically, this disclosure relates to automating transactions for operational systems.

### BACKGROUND

For information technology (IT) business enterprises to run smoothly in a constantly-evolving technological landscape, operational systems require extreme levels of precision and attention from operators and users of the system. Computer operators of these systems are responsible for performing functions that are essential to the continuation of the information flow between several systems, such as inventory control systems and accounting systems. Some of these functions may be as simple as answering a message or as complex as converting a Gregorian date to a Julian date. These operators must act quickly to avoid any malfunctions that can occur in the system.

In one particular scenario, read-and-reply messages are transmitted daily to system operators by batch jobs. Conventionally, a read-and-reply message must be answered by the operator. To answer the message, the operator must first open a transaction system emulator. Then, he has to navigate to specific fields in a user interface. After calculating the correct Julian day number based on a set of complex business rules, the resulting number must then be submitted into a transactional accounting system. All of these tasks must be performed by human interaction, and this can and has led to mistakes made by the human operators that have caused great disruption in the system's flow as well as a loss of profits due to the time spent to correct the error. Furthermore, although the use of human operators are necessary to perform some of the complex tasks, such as calculating complex Julian day numbers, the use of operators comes with significant overhead costs for an organization, and an increase in operator headcount ultimately results in decreased profitability.

### SUMMARY

An automated computer system described below may be implemented that allows automatically performing complex operational tasks, such as calculating Julian day numbers, for answering read-and-reply console messages generated by batch jobs. A read-and-reply message may also be referred to as an Outstanding Message, because in certain cases the message must be answered by an operator if not handled by automation. The automated system may be triggered when a host system receives information that one or more read-and-reply console messages have been generated. The automated system may be configured, for example in an accounting system, to calculate Julian day numbers and provide verification that the Julian day numbers have been confirmed. Upon conformation, the read-and-reply console message may be answered. Implementation of this system may remove the need of a human operator to perform any or all of the tasks associated with facilitating read-and-reply console messages.

Additionally, a method may be invoked to determine if the automated system is available for use. This determination may be made through the creation of a variable used for checking the status of a command. When the variable is created, normal commands to a host system may not be received. A test command may be sent to the host system to determine of the automated system is functioning properly. If the host system receives the command, the host system may return a response back indicating that the automated system is functioning properly. When the response is received, the variable may be destroyed. The ability to check the operable status of the automated system is an independent feature that may be implemented for several other systems as desired.

In one embodiment, to ensure certain mission-critical commands are processed correctly, command reliability measures may be taken. The automation language may supports Variable Group constructs and programmatic methods for testing the existence, plus creation and deletion, of certain elements, which may be referred to as Variable Group Members. These capabilities may ensure command access availability. For submission of automated cross-system commands a host may be determined whether the receiving session is active and can accept commands. If this is not the case, exception alerts may be raised instead. To this end, fail-safe session command access variables may be created and stored in the global variables. Session initialization starts with the assumption that command access is not available. With this variable in existence, no commands will be attempted, but an exception alert is instead raised. A test command may be sent, and the successful receipt of this command may destroy the fail-safe variable. This variable creation, test, and variable removal sequence may be performed on a regular basis and/or immediately before crucial transaction automation scenarios.

According to one embodiment, a method may include receiving one or more read-and-reply console messages and information associated with the one or more read-and-reply console messages from a message system; invoking an automation sequence in response to receiving the one or more read-and-reply console messages and information associated with the one or more read-and-reply console messages, where invoking the automation sequence includes calculating one or more Julian numbers; and notifying the message system that the one or more read-and-reply console messages can be answered by the message system in response to verifying that the automation sequence associated with the one or more read-and-reply console messages is confirmed.

According to another embodiment, a method may include creating a variable to prevent a system from receiving one or more commands; transmitting a test command to a host system; receiving a response from the host system indicating that the test command was received; and destroying the variable in response to the indication that the test command was received.

According to a further embodiment, an apparatus may include a processor and a memory coupled to the processor. The processor may be configured to perform the steps of receiving one or more read-and-reply console messages and information associated with the one or more read-and-reply console messages from a message system; invoking an automation sequence in response to receiving the one or more read-and-reply console messages and information associated with the one or more read-and-reply console messages, where invoking the automation sequence includes calculating one or more Julian numbers; and notifying the message system that the one or more read-and-reply console messages can be answered by the message system in response to verifying that the automation sequence associated with the one or more read-and-reply console messages is confirmed.

According to yet another embodiment, an apparatus may include a processor and a memory coupled to the processor. The processor may be configured to perform the steps of creating a variable to prevent a system from receiving one or more commands; transmitting a test command to a host system; receiving a response from the host system indicating that the test command was received; and destroying the variable in response to the indication that the test command was received.

According to an additional embodiment, a computer program product may include a non-transitory computer readable medium containing instructions which, when executed by a processor of a computing system, cause the processor to receive one or more read-and-reply console messages and information associated with the one or more read-and-reply console messages from a message system; invoke an automation sequence in response to receiving the one or more read-and-reply console messages and information associated with the one or more read-and-reply console messages, where the instructions that cause the processor to invoke the automation sequence further comprise instructions which, when executed by a processor of a computing system, cause the processor to calculate one or more Julian numbers; and notify the message system that the one or more read-and-reply console messages can be answered by the message system in response to the non-transitory computer readable medium comprising instructions which, when executed by a processor of a computing system, cause the processor to verify that the automation sequence associated with the one or more read-and-reply console messages is confirmed.

According to yet another embodiment, a computer program product may include a non-transitory computer readable medium containing instructions which, when executed by a processor of a computing system, cause the processor to create a variable to prevent a system from receiving one or more commands; transmit a test command to a host system; receive a response from the host system indicating that the test command was received; and destroy the variable in response to the indication that the test command was received.

The foregoing has outlined rather broadly the features and technical advantages of the present invention in order that the detailed description of the invention that follows may be better understood. It is first noted here that the terms “transaction” and “action” may be synonymous throughout this disclosure. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a limitation of the present invention.

### BRIEF SUMMARY OF THE DRAWINGS

For a more complete understanding of the disclosed system and methods, reference is now made to the following descriptions taken in conjunction with the accompanying drawings.

FIG. 1 is an illustration of a computing system detailing how a read-and-reply console message may be answered and how the process of verifying read-and reply console messages may be automated according to one embodiment.

FIG. 2 is a flowchart illustrating a method of verifying automation sequences of receiving and answering read-and-reply console messages according to one embodiment.

FIG. 3 is a flowchart illustrating a method of determining if an automation sequence is available according to one embodiment.

FIG. 4A is an illustration of computer-implemented instructions which, when executed by a processing unit of a message system, cause the processing unit to test the availability of the automation sequence according to one embodiment.

FIG. 4B is an illustration of computer-implemented instructions which, when executed by a processing unit of a message system, cause the processing unit to determine if the automation sequence is available in response to testing its availability according to one embodiment.

FIG. 5 illustrates one embodiment of a system for transferring information, including a system for receiving read-and-reply console messages and testing an automation sequence according to one embodiment.

FIG. 6 illustrates a computer system adapted according to certain embodiments of the server and/or the user interface device.

### DETAILED DESCRIPTION

### Receiving and Answering Read-and-Reply Console Messages Automatically

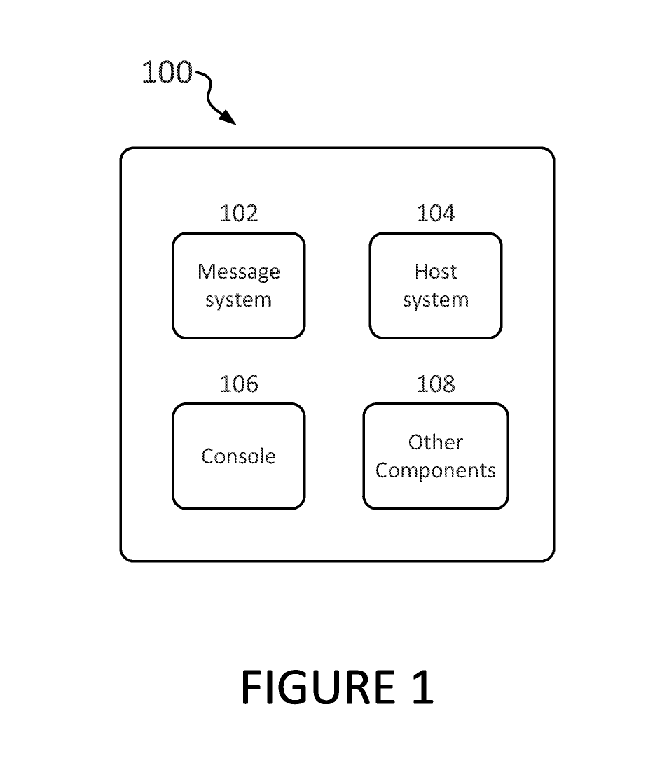

FIG. 1 is an illustration of a computing system detailing how a read-and-reply console message may be answered and how the process of verifying read-and reply console messages may be automated according to one embodiment. The computing environment 100 may contain a message system 102, a host system 104, a console 106, and other components 108 as needed or desired to the computing system 100. Each of the components 102, 104, 106, and 108 of computing environment 100, including computing system 100, may contain one or more central processing units, processors, databases, user interfaces, random access memory (RAM), a read only memory (ROM), one or more system buses, a keyboard, a pointing device, a touch screen, an input/output (I/O) adapter, a communications adapter, a user interface adapter, a display adapter, and other computing components. The message system 102 may be configured to control and manage read-and-reply console messages sent to the console 106. A read-and-reply console message may contain critical information that requires a response to allow the batch job to proceed with execution of further calculations. When a read-and-reply console message is received at the console 106, a copy of the read-and-reply console message and/or information associated with the read-and-reply console message, such as a notice of a read-and-reply console message, may be automatically transferred to the host system 104.

When the host system 104 determines that a read-and-reply console message has been sent, the host system 104 may automatically perform complex operations automatically in response to receiving the read-and-reply console message. The host system 104 may reside within the computing system 100, may be coupled to system 100, or may be external to the computing system 100 but controlled by any component of system 100. Host system 104 may include operating systems, such as Operations Sentinel 2200 (OS2200) and Master Control Program (MCP) of UNISYS. Part of the complex calculations performed at the host system 104 may include calculating Julian day numbers.

The calculation of a Julian day number may be unique to a particular system and may be based on a set of complex business rules. For example, calculating a Julian day number for an accounting system may be disparate from calculating a Julian day number for an inventory system. In accounting systems, Julian day number calculations may need to be performed for the current date. This may form the basis for additional logic that is required on a per-application and day-of-week runtime basis. In one embodiment, when a specific accounting job runs on a Monday, the previous month-end's Julian day number may be used instead of the current Julian day number. In another embodiment, after a holiday, such as Easter which can fall on different dates each year, the Julian day number for the previous Friday may be used. These calculations may be defined by business rules.

The console 106 may operate the computing system 100. In some embodiments, terminal emulators may be substituted in place of the consoles to control the computing system 100 remotely and in a different computing environment. Some computing systems may provide telnet-based console connections to any system if the system is using an open networking protocol. This may allow the message system 102 and the host system 104 to communicate with the console 106. The console 106 may be configured to receive verification that an automation sequence has been successfully completed, and as a result, the console displays a message to the message system 102 that the read-and-reply console message may be answered. In other words, when a read-and-reply console message is transmitted to the host system 104, a Julian day number associated with the read-and-reply console message may be calculated at the host system 104, and the console 106 may receive verification that the Julian day number is correct for the read-and-reply console message to be answered. The console 106 may be coupled to the host system 104 through a telnet-based connection, and the message system 102 may be notified that the read-and-reply console message may be answered by the host system 104 through the console 106. If the verification is successful, the message system 102 may answer the read-and-reply console message.

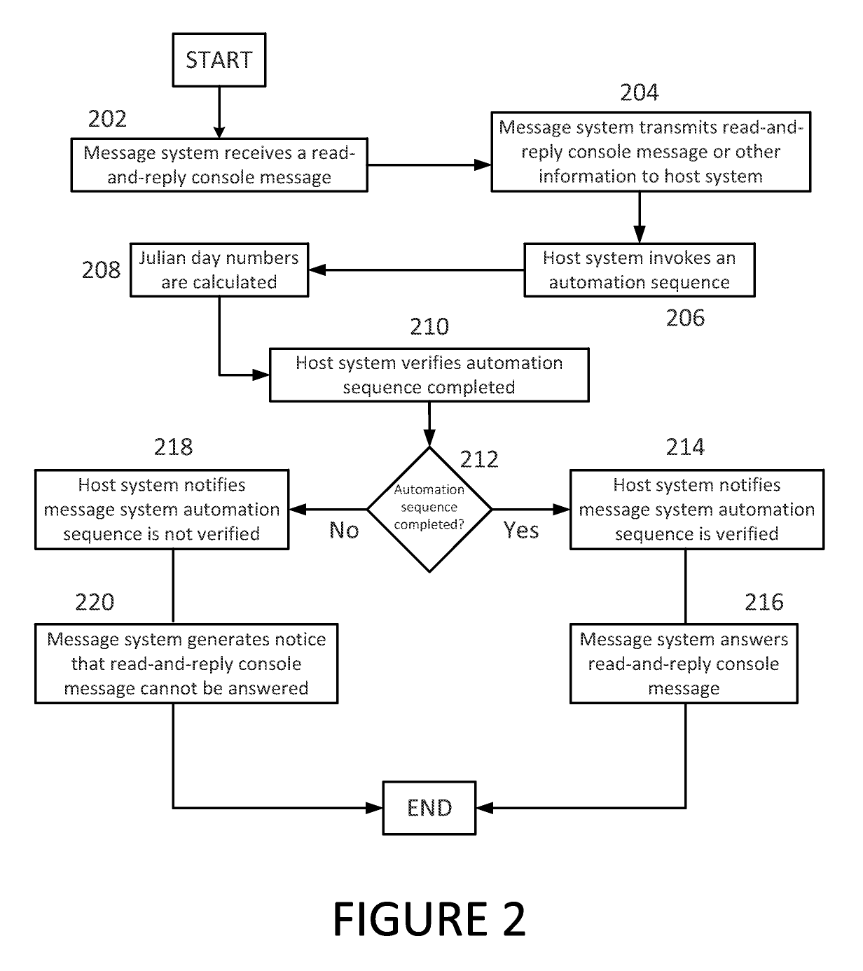

FIG. 2 is a flowchart illustrating a method of verifying automation sequences of receiving and answering read-and-reply console messages according to one embodiment. The method begins at step 202 where the message system 102 may receive a read-and-reply console message. The read-and-reply console message may be a message that contains questions or statements. These read-and-reply console messages may require an answer before a system task can continue to proceed. In one embodiment, the console 106 may receive the read-and-reply console message directly, thus bypassing the receipt of the read-and-reply console message by the message system 102. In this case, the message system 102 may alternatively receive an indication, such as a notice, that a read-and-reply console message has been received at the console 106. At step 204, the message system 102 transmits the read-and-reply console message and/or any information associated with the read-and-reply console message to the host system 104. In some embodiments, step 204 may be performed in response to the message system 102 receiving an indication that the read-and-reply console message has been received by the console 106.

To activate the process of answering the read-and-reply console message, at step 206, the host system 104 may invoke an automation sequence that includes the calculation of a Julian day number. Any Julian day numbers associated with the read-and-reply console message may be calculated at step 208. The Julian day numbers may be calculated automatically within the automation sequence, thus alleviating the need for a human operator to perform the calculation manually. The host system 104 may verify that the automation sequence is completed at step 210. All or a part of the automation sequence may include calculating a new Julian day number and comparing that Julian day number to a current Julian day number that exists in the system to determine a match. If it is determined that the automation sequence is completed (a “Yes” response from the decision diamond at step 212), the host system 104 may notify the message system 102 that the automation sequence is verified at step 214. In turn, the message system 102 may answer the read-and-reply console message at step 216. Conversely, if it is determined that the automation sequence is not completed (a ‘No’ response from the decision diamond at step 212), the host system 104 may notify the message system 102 that the automation sequence is not verified at step 218. Afterwards, the message system may generate a notice on the console 106 that the read-and-reply console message cannot be answered at step 220. Methods of troubleshooting the automation sequence and/or repairing any components of the system 100 may be performed, but details of these methods are not within the scope of this disclosure. After either of the steps 216 or 220, the method terminates although the method may be repeated for additional read-and-reply messages.

### Testing Automation Sequence Availability

In addition to verifying that a message can be answered, the message system 102 may determine if an automation sequence is available. This may be accomplished by allowing the message system 102 to send a test command to the host system 104 and waiting for a predetermined amount of time to receive a return response from the host system 104. If the message system 102 receives a response from the host system 104, the automation sequence may be available. If the message system 102 does not receive a response from the host system 104, then the automation sequence may not be available or may be in a nonfunctioning state.

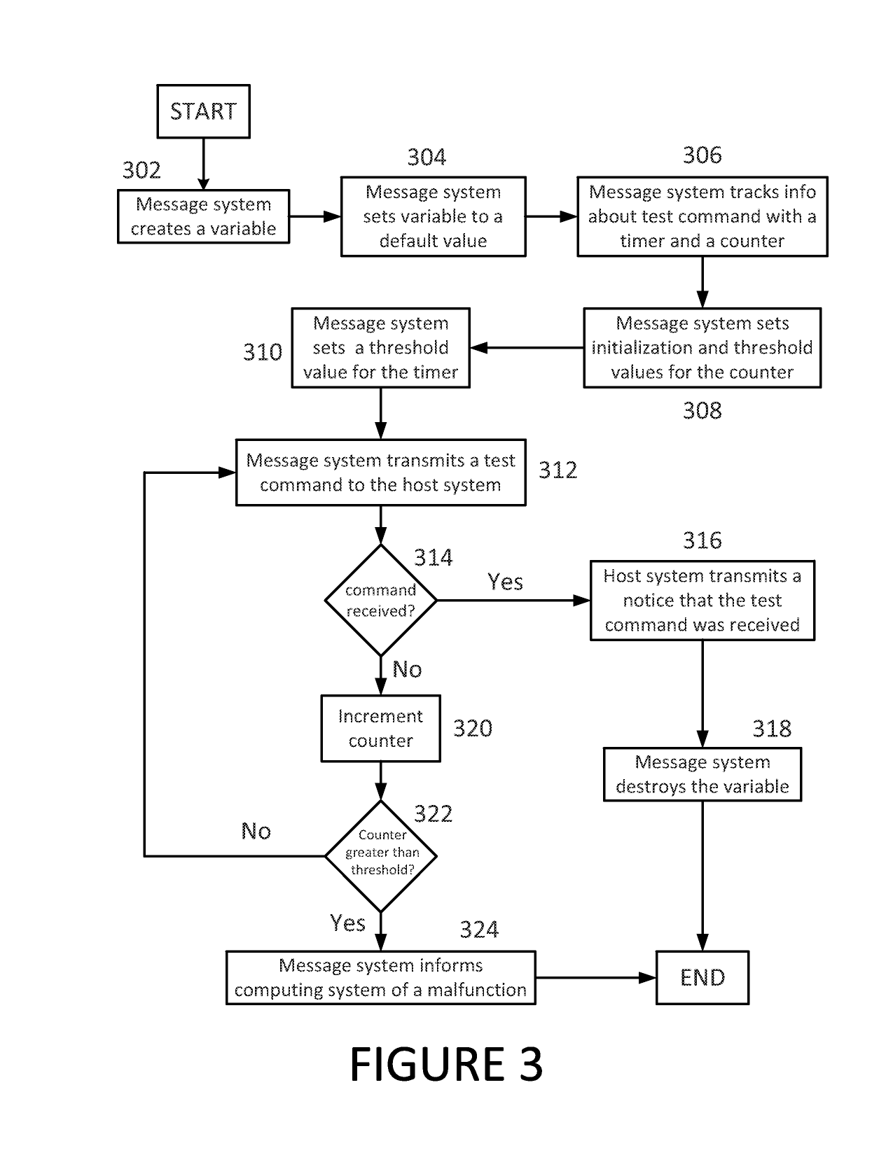

FIG. 3 is a flowchart illustrating a method of determining if an automation sequence is available according to one embodiment. The method begins at step 302 where the message system 102 may create a test variable that signifies that the automation sequence is not available. At step 304, the test variable may be set to a default value. In one embodiment, the test variable may be entitled “CmdAccessNotOK,” and the default value may be “ZERO.” In addition to creating a test variable, the message system 102 may track the information associated with the test command with a test command timer and a test command counter at step 306. The test command timer may be used to track the amount of time that has elapsed before a return response has been received. The test command counter may be used to count the number of tests that have been completed until a threshold has been met. At step 308, the message system 102 may set an initialization value and a threshold value for the test command counter. The initialization value may be smaller than the threshold value if the test command counter is an incrementing counter. Conversely, the initialization value may be larger than the threshold value if the test command counter is a decrementing counter. At step 310, the message system 102 may set a threshold value for the test command timer. The initialization and threshold values for the test command counter and the threshold value for the test command timer may be set to any value. Additionally, other timers and counters may be utilized for the purposes of determining the availability of an automation sequence.

After the test command timer and counter have been set, the message system 102 may transmit a test command to the host system 104 to determine if the automation sequence is available at step 312. This command transmission may be a wakeup signal to the host system 104. At step 314, a determination is made as to whether the test command was received by the host system 104. If the test command is received by the host system 104 (a “Yes” response from the decision diamond at step 314), the host system 104 may transmit a notice to the message system 102 that the test command was received at step 316. This notice may signify that the automation sequence is available. In one embodiment, the value of the test variable “CmdAccessNotOK” may be altered to a value or an expression that signifies to the message system 102 that the automation sequence is available. After the notice is received by the message system 102, the message system 102 may destroy the test variable at step 318. In an alternate embodiment, the test variable may be deactivated after the notice is received by the message system 102, and reactivated each time the availability of an automation sequence is determined. The method may terminate after step 318. Additionally in some embodiments, in response to destroying the test variable, the message system 102 may transmit a separate notice to the computing system 100 that the automation sequence is available.

If the test command is not received by the host system 104 (a “No” response from the decision diamond at step 314), the initialization value of the test command timer may be incremented to a new value at step 320. The determination that the test command was not received may be made in response to the threshold value of the test command timer being reached. After the counter is incremented, a second decision diamond may be encountered at step 322 as to whether the incremented value of the test command counter is greater than the threshold value. If the incremented value of the test command counter is greater than the threshold value (a “Yes” response from the decision diamond at step 314), the message system may inform the computing system or any repair system (or entity that handles repairs and malfunctions) that the automation sequence is in a nonfunctioning state. After step 324, the method terminates or may return to step 302 and execute again. If at step 314 the incremented value of the test command counter is not greater than the threshold value (a “No” response from the decision diamond at step 314), the method may revert back to step 312 where the message system 102 may transmit the same or another test command to the host system 104. The steps following step 312 may be performed iteratively until a test command (whether previously transmitted or newly generated) is received by the host system 104, a threshold is surpassed or reached, or the method is terminated for any reason.

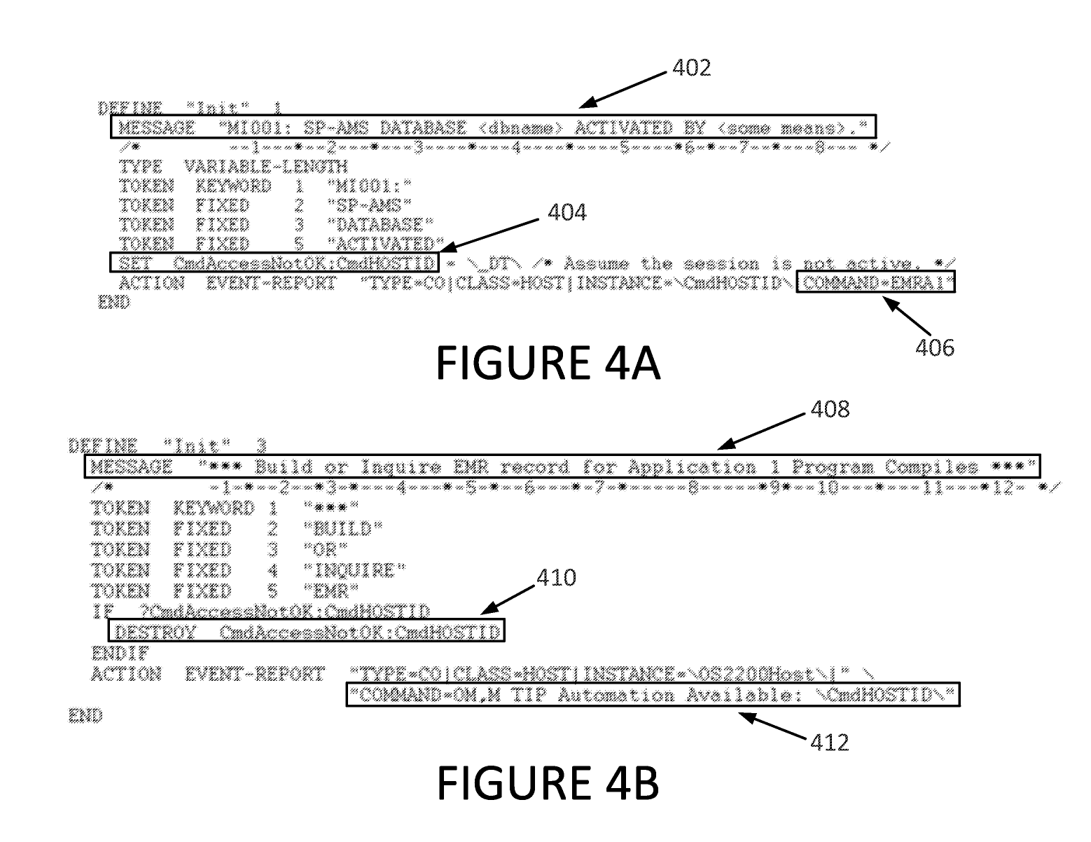

FIG. 4A is an illustration of computer-implemented instructions which, when executed by a processing unit of a message system, cause the processing unit to test the availability of the automation sequence according to one embodiment. A message 402 may be generated at the message system 102 to activate a database. The message may display the database name as well as a means for activating the database. A test variable may be created 404 called “CmdAccessNotOK.” When this variable is created, the host system 104 may not receive any commands from the message system 102 or the automation sequence may not be available. Alternatively, the test variable may already exist in the computer-implemented instructions. If this is the case, the test variable may be set to a default value. After the test variable is created, a test command 406 may be transmitted to the host system 104. In this example, the test command is “EMRA1” which stands for EMR Application 1. After the test command 406 is transmitted to the host system 104, the message system 102 may wait to receive a return message from the host system 104 for a predetermined amount of time.

FIG. 4B is an illustration of computer-implemented instructions which, when executed by a processing unit of a message system, cause the processing unit to determine if the automation sequence is available in response to testing its availability according to one embodiment. If the host system 104 receives the test command 406 from the message system 102, the host system 104 may transmit a notice in the form of a return message 408 to the message system 102 signaling that the message was received. This notice 408 may read “Build or Inquire EMR record for Application 1 Program Compiles,” thus informing the message system 102 that the test command 406 was received. Receipt of the test command 406 and the transmission of the notice 408 may signal that the automation sequence is available. Upon receipt of the notice 408, the message system 102 may be configured to destroy the test variable 410. Alternatively, the test variable may not be destroyed and may be set to a value that represents that the test command 406 was received and the automation sequence is available. In response to destroying the test variable, the message system 102 may be configured to transmit a separate notice 412 to the computing system 100 that the automation sequence is available. All of the computer-implemented instructions of FIGS. 4A and 4B may be performed by a processing unit that may control some or all of the functions of the message system 102.

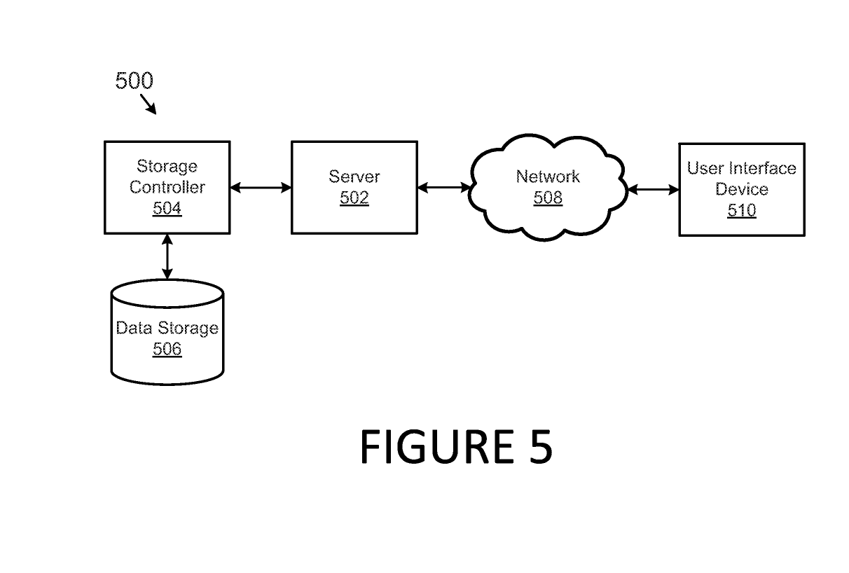

FIG. 5 illustrates one embodiment of a system for transferring information, including a system for receiving read-and-reply console messages and testing an automation sequence according to one embodiment. The system 500 may include a server 502, a data storage device 506, a network 508, and a user interface device 510. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508. The system 500 may support running of automated batches by hosting the message system 102 of FIG. 1 on the computing system 100.

In one embodiment, the user interface device 510 is referred to broadly and is intended to encompass a suitable processor-based device such as a desktop computer, a laptop computer, a personal digital assistant (PDA) or tablet computer, a smartphone, or other mobile communication device having access to the network 508. In a further embodiment, the user interface device 510 may access the Internet or other wide area or local area network to access a web application or web service hosted by the server 502 and may provide a user interface for communicating with the message system 102, the host system 104, the console 106, and/or any of the other components 108 that may be controlled by separate processing units of FIG. 1.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

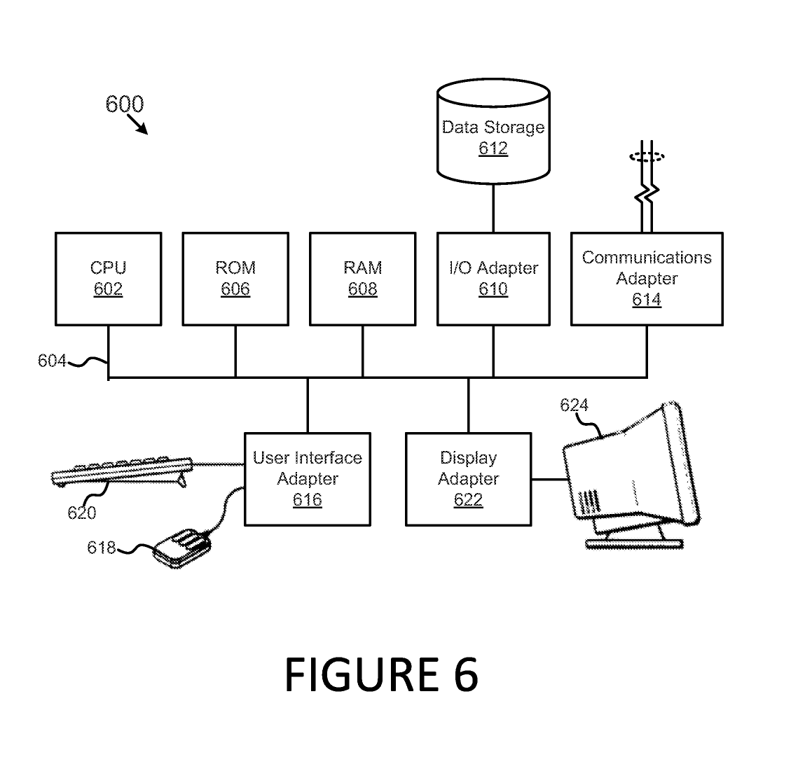

FIG. 6 illustrates a computer system adapted according to certain embodiments of the server and/or the user interface device. The central processing unit (“CPU”) 602 is coupled to the system bus 604. Although only a single CPU is shown, multiple CPUs may be present. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 may also include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 608, which may be one or more of a LAN, WAN, and/or the Internet. The user interface adapter 616 couples user input devices, such as a keyboard 620, a pointing device 618, and/or a touch screen (not shown) to the computer system 600. The keyboard 620 may be an on-screen keyboard displayed on a touch panel. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASICs), very large scale integrated (VLSI) circuits, or other circuitry. In fact, persons of ordinary skill in the art may utilize any number of suitable structures capable of executing logical operations according to the described embodiments. For example, the computer system may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
creating, by a message system, a variable to prevent a system from receiving one or more commands;
transmitting, by the message system, a test command to a host system;
receiving, by the message system, a response from the host system indicating that the test command was received; and
destroying, by the message system, the variable in response to the indication that the test command was received.

2. The method of claim 1, further comprising transmitting, by the message system, a notice to the computing system that an automation sequence is available in response to destroying the variable.

3. The method of claim 1, where the variable is set to a default value.

4. The method of claim 1, further comprising tracking, by the message system, information associated with the test command with a test command timer and a test command counter.

5. The method of claim 4, where a first threshold value is set for the test command timer.

6. The method of claim 4, where an initialization value and a second threshold value is set for the test command counter.

7. The method of claim 1, further comprising deactivating, by the message system, the variable in response to receiving the response indicating that the test command was received.

8. An apparatus, comprising:
a processor, and
a memory coupled to the processor, where the processor is configured to perform the steps of:
creating a variable to prevent a system from receiving one or more commands;
transmitting a test command to a host system;
receiving a response from the host system indicating that the test command was received; and
destroying the variable in response to the indication that the test command was received.

9. The apparatus of claim 8, where the processor is further configured to perform the step of transmitting a notice to the computing system that an automation sequence is available in response to destroying the variable.

10. The apparatus of claim 8, where the variable is set to a default value.

11. The apparatus of claim 8, where the processor is further configured to perform the step of tracking information associated with the test command with a test command timer and a test command counter.

12. The apparatus of claim 11, where a first threshold value is set for the test command timer.

13. The apparatus of claim 11, where an initialization value and a second threshold value is set for the test command counter.

14. The apparatus of claim 8, where the processor is further configured to perform the step of deactivating the variable in response to receiving the response indicating that the test command was received.

15. A computer program product, comprising:
a non-transitory computer readable medium comprising instructions which, when executed by a processor of a computing system, cause the processor to:
create a variable to prevent a system from receiving one or more commands;
transmit a test command to a host system:
receive a response from the host system indicating that the test command was received; and
destroy the variable in response to the indication that the test command was received.

16. The computer program product of claim 15, where the non-transitory computer readable medium further comprises instructions which, when executed by the processor of the computing system, cause the processor to transmit a notice to the computing system that an automation sequence is available in response to the instructions that cause the processor to destroy the variable.

17. The computer program product of claim 15, where the non-transitory computer readable medium further comprises instructions which, when executed by the processor of the computing system, cause the processor to track information associated with the test command with a test command timer and a test command counter.

18. The computer program product of claim 17, where a first threshold value is set for the test command timer.

19. The computer program product of claim 17, where an initialization value and a second threshold value is set for the test command counter.

20. The computer program product of claim 15, where the non-transitory computer readable medium further comprises instructions which, when executed by the processor of the computing system, cause the processor to deactivate the variable in response to the instructions that cause the processor to receive the response indicating that the test command was received.
